(19) United States
(12) Patent Application Publication
(10) Pub. No.: US 2014/0351801 A1
(43) Pub. Date: Nov. 27, 2014

(54) FORMAL VERIFICATION APPARATUS AND METHOD FOR SOFTWARE-DEFINED NETWORKING

(71) Applicant: ELECTRONICS AND TELECOMMUNICATIONS RESEARCH INSTITUTE, Daejeon-city (KR)

(72) Inventors: Myung-Ki SHIN, Seoul (KR); Yun-Chul CHOI, Daejeon (KR); Jong-Hwa YI, Daejeon (KR); Seung-Ik LEE, Daejeon (KR); Hyoung-Jun KIM, Daejeon (KR)

(73) Assignee: ELECTRONICS AND TELECOMMUNICATIONS RESEARCH INSTITUTE, Daejeon-city (KR)

(21) Appl. No.: 14/284,768

(22) Filed: May 22, 2014

(30) Foreign Application Priority Data
May 27, 2013 (KR) 10-2013-0059830
Jan. 28, 2014 (KR) 10-2014-0010711

(51) Int. Cl. G06F 9/45

(52) U.S. Cl. CPC G06F 8/41
USPC 717/151

(57) ABSTRACT

The present invention relates to a formal technique-based verification apparatus and method for verifying software-defined networking. In accordance with an embodiment, a formal verification apparatus for Software-Defined Networking (SDN), includes a formal language creation unit for collecting flow table information for an entire network topology in response to a request of a SDN control unit, and creating description code in a predefined formal language based on the collected flow table information. A Symbolic Transition Graph (STG) generation unit generates a symbolic transition graph using the created description code in the formal language. A verification execution unit performs verification by applying formal verification technology to the symbolic transition graph.

### CROSS REFERENCE TO RELATED APPLICATIONS

This application claims the benefit of Korean Patent Application Nos. 10-2013-0059830 filed on May 27, 2013 and 10-2014-0010711 filed on Jan. 28, 2014, which are hereby incorporated by reference in their entirety into this application.

### BACKGROUND OF THE INVENTION

1. Technical Field

The present invention relates to a formal technique-based verification apparatus and method for verifying software-defined networking.

2. Description of the Related Art

Software-defined networking (hereinafter referred to as ‘SDN’) is chiefly characterized in that a network node is separated into devices for a data transmission function and a control function and is then composed of two devices, that is, an SDN node having only a hardware-based data transmission function and a programmable centralized software controller. Since a typical SDN scheme is configured such that network control or the like is executed by an external application program based on a software scheme, there is a high probability that the execution of an erroneously written external application program or an intentionally, falsely hacked application program may cause considerable damage to the entire network topology.

Therefore, in order to guarantee the execution of a secure SDN application program, there is a need to verify in advance all SDN application programs written using software. That is, there is a required a task for, before actual OpenFlow rules or the like are transferred from a controller to an SDN switch or the like at runtime in conformity with an OpenFlow protocol, verifying in advance the OpenFlow rules or the like.

Korean Patent Application Publication No. 10-2011-0109146 discloses a behavioral error analysis apparatus and method. However, in a typical SDN and OpenFlow development environment, technology has not yet been presented which can previously discover a loop that may occur on a network due to an erroneously written program or a conflict between OpenFlow rules that may occur when multiple application programs are executed on a single controller, can debug the loop or conflict, and can feed back errors.

### SUMMARY OF THE INVENTION

Accordingly, the present invention has been made keeping in mind the above problems occurring in the prior art, and an object of the present invention is to provide a formal verification apparatus and method using formal technique-based symbolic verification so that errors in SDN applications can be previously discovered and can be fundamentally removed.

In accordance with an aspect of the present invention to accomplish the above object, there is provided a formal verification apparatus for Software-Defined Networking (SDN), including a formal language creation unit for collecting flow table information for an entire network topology in response to a request of a SDN control unit, and creating description code in a predefined formal language based on the collected flow table information, a Symbolic Transition Graph (STG) generation unit for generating a symbolic transition graph using the created description code in the formal language, and a verification execution unit for performing verification by applying formal verification technology to the symbolic transition graph.

Preferably, the flow table information may include one or more of a matching field, a priority field, a counters field, and an action set field of OpenFlow.

Preferably, the predefined formal language may be a process algebra-based packet based Algebra of Communicating Shared Resources (pACSR).

Preferably, the formal language creation unit may convert the matching field into a conditional clause in the description code in the pACSR, and convert the action set field into an operator in the description code in the pACSR.

Preferably, the formal language creation unit may convert the flow table information into a process in the pACSR for each SDN switch, and parallelize converted processes for respective SDN switches into a single process.

Preferably, the STG generation unit may convert the created description code in the formal language into the symbolic transition graph based on a rule preset in the formal language.

Preferably, the preset rule may include any one of a parallel composition rule, a choice rule, an event rule, and a resource rule.

Preferably, the formal verification technology may include symbolic model checking.

Preferably, the verification execution unit may generate results of verification in a form of a Boolean expression implemented using a symbolic representation.

Preferably, the results of the verification in the form of the Boolean expression may include any one of a Binary Decision Diagram (BDD) and a Conjunctive Normal Form (CNF).

In accordance with another aspect of the present invention to accomplish the above object, there is provided a formal verification method for Software-Defined Networking (SDN), including collecting flow table information for an entire network topology in response to a request of an SDN control unit, creating description code in a predefined formal language based on the collected flow table information, generating a symbolic transition graph using the created description code in the formal language, and performing verification by applying formal verification technology to the symbolic transition graph.

Preferably, the flow table information may include one or more of a matching field, a priority field, a counters field, and an action set field of OpenFlow.

Preferably, the predefined formal language may be a process algebra-based packet based Algebra of Communicating Shared Resources (pACSR).

Preferably, creating the description code in the formal language may include converting the matching field into a conditional clause in the description code in the pACSR, and converting the action set field into an operator in the description code in the pACSR.

Preferably, creating the description code in the formal language may include converting the flow table information into a process in the pACSR for each SDN switch, and parallelizing converted processes for respective SDN switches into a single process.

Preferably, generating the symbolic transition graph may be configured to convert the created description code in the formal language into the symbolic transition graph based on a rule preset in the formal language.

Preferably, the preset rule may include any one of a parallel composition rule, a choice rule, an event rule, and a resource rule.

Preferably, the formal verification technology may include symbolic model checking.

Preferably, the formal verification method may further include generating results of verification in a form of a Boolean expression implemented using a symbolic representation.

Preferably, the results of the verification in the form of the Boolean expression may include any one of a Binary Decision Diagram (BDD) and a Conjunctive Normal Form (CNF).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a typical SDN environment;

FIG. 2 is a diagram showing an SDN environment to which a formal verification apparatus is applied according to an embodiment;

FIG. 3 is a diagram showing an example of the configuration of an SDN-based entire network topology;

FIG. 4 is a diagram showing an example of flow table information of OpenFlow for the SDN-based entire network topology;

FIG. 5 is a diagram showing an example of description code converted into a formal language (pACSR) according to an embodiment;

FIG. 6 is a diagram showing a symbolic transition graph converted from pACSR description code according to the embodiment of FIG. 5;

FIG. 7 is a diagram showing an example of symbolic verification for performing error verification using the symbolic transition graph of FIG. 6; and

FIG. 8 is a flowchart showing a formal verification method for SDN according to an embodiment.

### DESCRIPTION OF THE PREFERRED EMBODIMENTS

Details of embodiments are included in detailed description and attached drawings. The features and advantages of technology disclosed in the present invention and methods for achieving them will be more clearly understood from detailed description of the following embodiments taken in conjunction with the accompanying drawings. Reference now should be made to the drawings, in which the same reference numerals are used throughout the different drawings to designate the same or similar components.

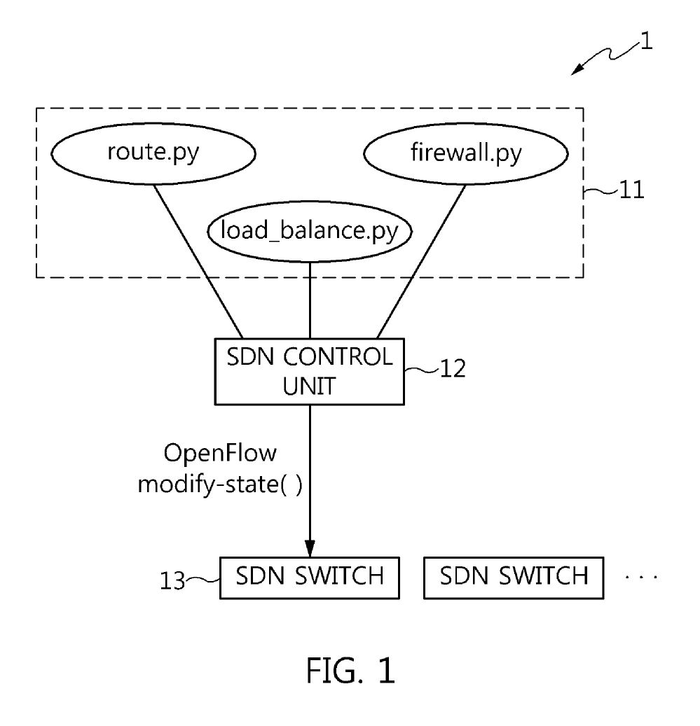

FIG. 1 is a diagram showing a typical Software-Defined Networking (SDN) environment.

As shown in FIG. 1, in a typical SDN environment 1, various application programs 11 written using software are executed on an SDN control unit 12 at runtime, and the SDN control unit 12 downloads instructions or the like generated as a result of the execution to an SDN switch 13 to control the SDN switch 13.

Applications programmed in a Python language, for example, route.py, load_balance.py, firewall.py, etc., are executed by a Plain Old XML (POX) controller which is a Python language-based SDN control unit 12. The POX controller may pass instructions or the like generated as a result of the execution down to the SDN switch 13 or the like using an OpenFlow protocol (for example, modify_state( )message).

However, the typical SDN environment 1 is configured such that, as the control or the like of a network is executed by an external application program using a software scheme, serious damage may be caused in the entire network topology when an erroneously written application program or an intentionally falsely hacked application program is executed.

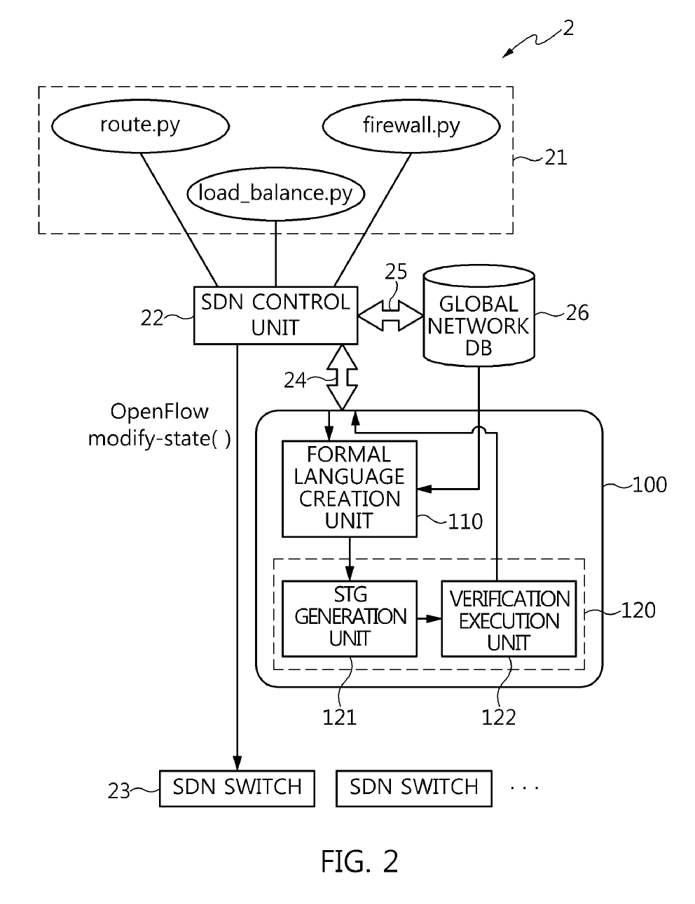

Below, a formal verification apparatus and method for verifying in advance various applications in an SDN environment will be described in detail with reference to FIGS. 2 to 8.

Meanwhile, although a Python language and OpenFlow protocol-based SDN environment 2 is described by way of example, it is apparent that this is only an example given for the convenience of description, and such an environment is not limited by a language required to create applications or the type of protocol.

FIG. 2 is a diagram showing an SDN environment to which a formal verification apparatus is applied according to an embodiment.

As shown in FIG. 2, an SDN environment 2 according to an embodiment includes a formal verification apparatus 100 for verifying in advance various types of applications using a formal technique. An SDN control unit 22 executes external applications 21 such as route.py, load_balance.py, and firewall.py, and stores OpenFlow table information or like generated as a result of the execution in a global network DB 26 via an interface 25.

The SDN control unit 22 transmits the instructions or the like generated as a result of the execution to the formal verification apparatus 100 through an interface 24 before transmitting the instructions or the like to an SDN switch 23, thus enabling the instructions or the like to be verified in advance.

If a verification request is received from the SDN control unit 22, the formal verification apparatus 100 performs formal verification using OpenFlow table information about an SDN-based entire network topology stored in the global network DB 26, and transmits the results of verification to the SDN control unit 22.

If the results of the verification are received from the formal verification apparatus 100 through the interface 24, the SDN control unit 22 determines whether an error is present in the results of the verification. If it is determined that an error is not present, the SDN control unit 22 downloads OpenFlow rules or the like to the SDN switch 23 using an OpenFlow protocol (for example, modify_state ( )message) and allows the OpenFlow rules or the like to be incorporated into the network. If it is determined that an error is present in the results of the verification, the SDN control unit 22 transmits error information to external applications, thus allowing the error to be corrected.

Referring to FIG. 2, the formal verification apparatus 100 according to the embodiment may include, in detail, a formal language creation unit 110 and a formal verification unit 120. Further, the formal verification unit 120 may include, in detail, a Symbolic Transition Graph (STG) generation unit 121 and a verification execution unit 122.

Meanwhile, as shown in the drawing, the formal verification apparatus 100 may be implemented in a hardware device other than the SDN control unit 22. Further, the formal language creation unit 110 and the formal verification unit 120 of the formal verification apparatus 100, or the STG generation unit 121 and the verification execution unit 122 of the formal verification unit 120 may be implemented in a single hardware device or may be independently implemented in different hardware devices.

If a verification request from the SDN control unit 22 is received, the formal language creation unit 110 collects flow table information related to the entire network topology from the global network DB 26.

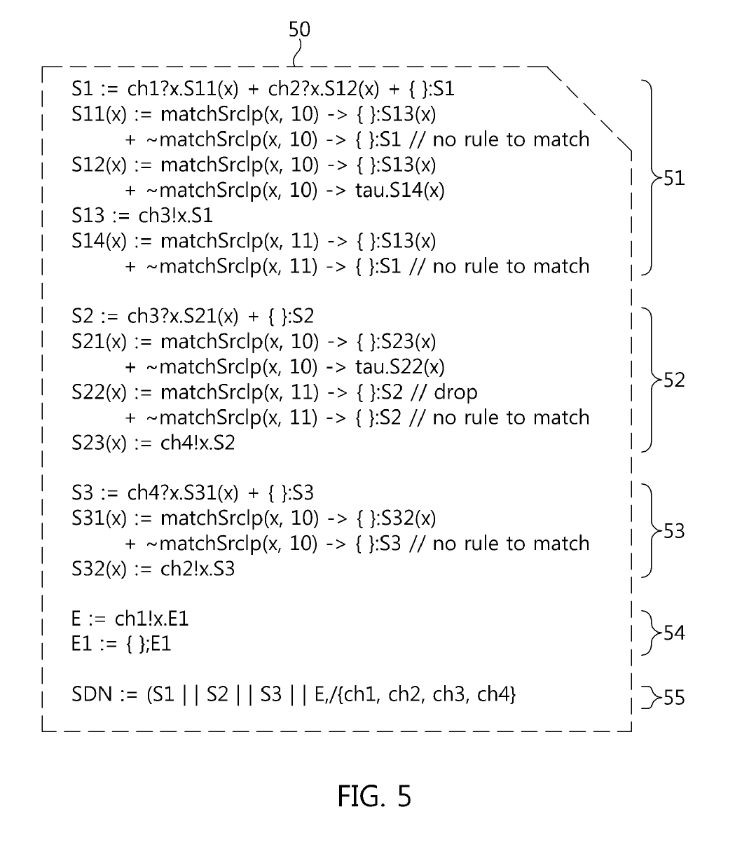

If the flow table information has been collected, the formal language creation unit 110 creates description code in a predefined formal language using the collected flow table information. Here, the predefined formal language may be a process algebra-based packet based Algebra of Communicating Shared Resources (pACSR) formal language, and this will be described in detail later with reference to FIG. 5.

The formal verification unit 120 may verify the created description code in the formal language using a formal technique, and transmit the results of the verification to the SDN control unit 22 through the interface 24.

The STG generation unit 121 generates a symbolic transition graph using the created formal language description code.

The STG generation unit 121 may convert the created formal language description code into the symbolic transition graph in compliance with a rule preset in the formal language. In this case, the rule preset in the formal language may include a parallel composition rule, a choice rule, an event rule, a resource rule, etc. As an example, the symbolic transition graph may be generated using a scheme such as “symbolic schedulability analysis of real-time system.”

The verification execution unit 122 verifies whether an error such as a loop is present in the symbolic transition graph by applying formal verification technology to the generated symbolic transition graph. In this case, the formal verification technology may include a symbolic model checking technique used in formal theory to perform symbolic verification.

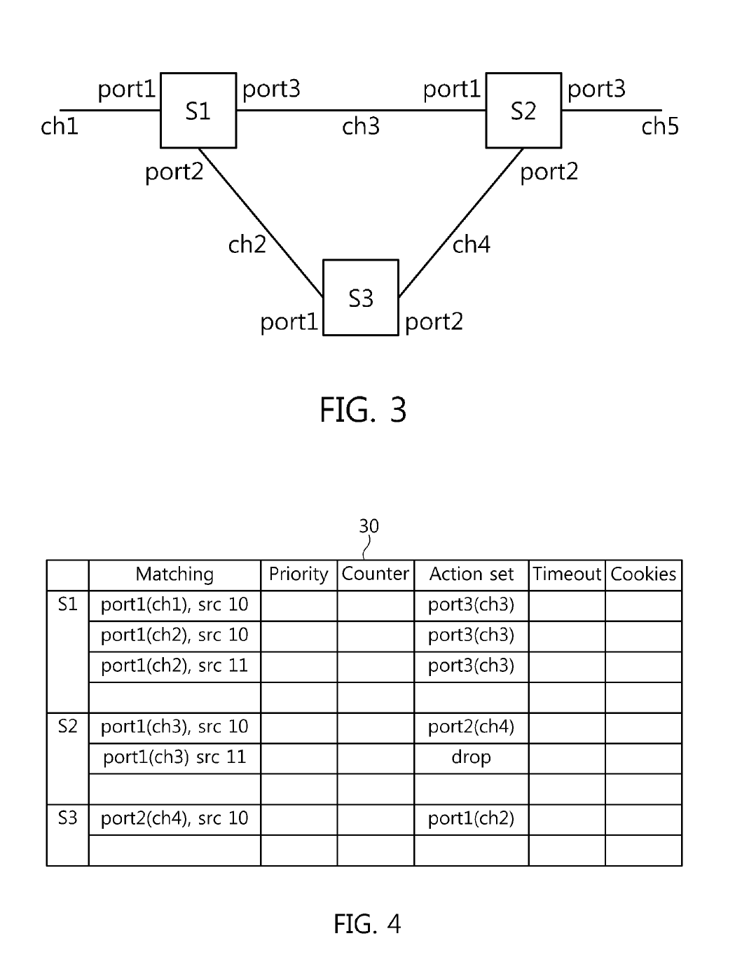

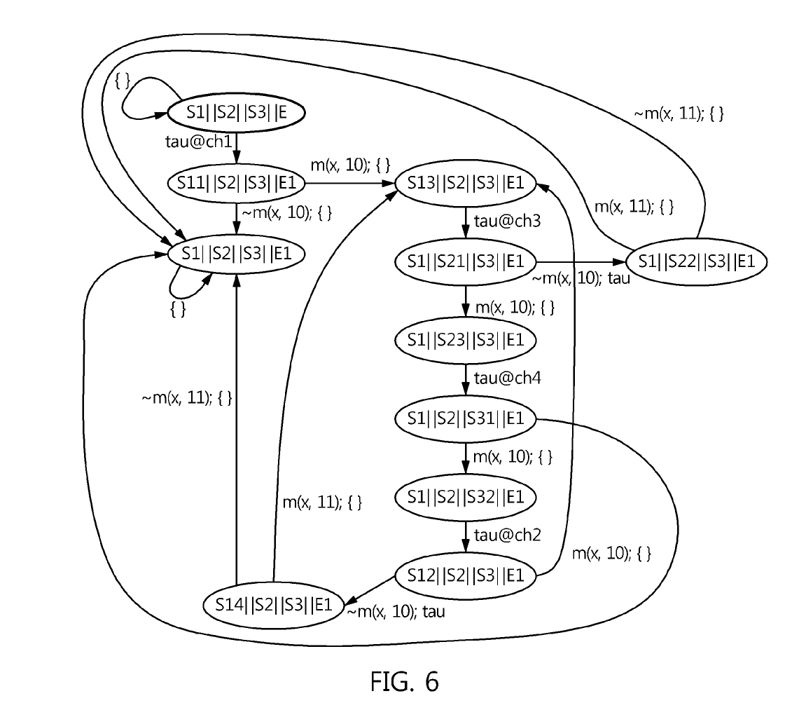

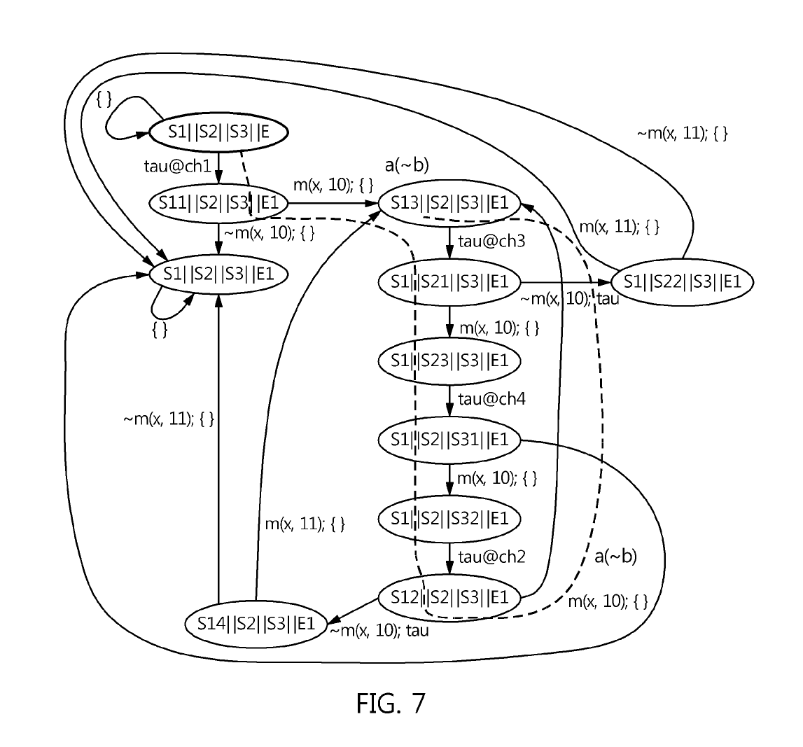

If verification has been completed, the verification execution unit 122 transmits the results of the verification to the SDN control unit 22 through the interface 24. FIG. 3 is a diagram showing an example of the configuration of an SDN-based entire network topology. FIG. 4 is a diagram showing an example of flow table information of OpenFlow for the SDN-based entire network topology. FIG. 5 is a diagram showing an example of description code converted into a formal language (pACSR) according to an embodiment. FIG. 6 is a diagram showing a symbolic transition graph converted from pACSR description code according to the embodiment of FIG. 5. FIG. 7 is a diagram showing an example of symbolic verification for performing error verification using the symbolic transition graph of FIG. 6.

Below, a procedure for performing formal verification in the formal verification apparatus 100 will be described by way of example in detail with reference to FIGS. 2 to 7.

FIG. 3 illustrates a network topology composed of three SDN switches 23 S1, S2, and S3, wherein each SDN switch 23 has one or more of ports, for example, port1, port2, and port3, and connections between individual SDN switches 23 are indicated by channels ch2, ch3, ch4, etc.

FIG. 4 illustrates a flow table 30 stored in the global network DB 26 for the network topology illustrated in FIG. 3. The flow table 30 may include fields, such as for matching, priority, counters, action set, timeout, and cookies. In the present embodiment, a description will be made based on the matching field corresponding to the input condition of the flow table 30 and the action set field required to conduct an action corresponding to the condition, among various fields of the flow table 30.

If a verification request from the SDN control unit 22 is received, the formal language creation unit 110 acquires the information of the flow table 30, such as that shown in FIG. 4, from the global network DB 26.

If the information of the flow table 30 has been acquired, the formal language creation unit 110 converts the various fields of the flow table 30 into description code predefined in the pACSR, and represents the behavior (action) of the SDN switch 23 which executes the flow table 30 by description code 50 such as that shown in FIG. 5.

For example, when, in OpenFlow, the matching field of the flow table 30 matches the input condition, an action set is executed, and thus the formal language creation unit 110 may convert the matching field of the flow table into a conditional clause in pACSR. In this case, various functions of the matching field may be converted into conditional clauses by using predefined predicates and functions that are pACSR elements.

Further, the formal language creation unit 110 converts instructions of the action set field of the flow table 30 into predefined operators in pACSR. In this case, pACSR supports the symbols (∥) of a parallel composition. The behavior of the entire SDN system including the SDN control unit 22, the SDN switches 23, hosts, etc. may be converted into pACSR as a single system using the symbols (∥) of such a parallel composition.

For example, the formal language creation unit 110 independently converts individual flow fields into a single process for each SDN switch using the parallel composition symbols of pACSR, and parallelizes the descriptions of respective converted processes using the parallel composition symbols, thus converting the flow fields into a single system.

In accordance with the embodiment of the present invention, the formal language creation unit 110 automatically performs such a conversion process without visually representing the conversion process to users. Even for other fields in the flow table 30, a conversion process may be performed using the rule preset in pACSR.

The pACSR description code converted from the flow table of FIG. 4 will be described in detail below with reference to FIG. 5. As shown in the drawing, description code 50 created by converting the flow table 30 of FIG. 4 into pACSR may include a process 51 obtained by converting the behavior of the SDN switch 23 S1, a process 52 obtained by converting the behavior of the SDN switch 23 S2, a process 53 obtained by converting the behavior of the SDN switch 23 S3, a process 54 for host E, and a process 55 for the entire SDN system. In this case, a process SDN may be generated by combining the process S1 51, process S2 52, process S3 53, and process E 54 of the respective SDN switches 23 in parallel.

In accordance with the flow table 30 of FIG. 4, the action (behavior) of the SDN switch 23 S1 is conducted such that, if a packet is received through a channel 1 (ch1), and a source IP address matches 10, the packet is sent through a channel 3 (ch3), whereas if the source IP address does not match 10, the packet is dropped. Similarly, if a packet is received through a channel 2 (ch2), a source IP address is checked. Then, if the source IP address matches 10, the packet is output to the channel (ch3) (egress operation). If the source ID address of a packet input through the channel 2 (ch2) matches 11, it can be seen that the packet is output through the channel 3 (ch3) (egress operation), and all other packets are dropped. In this case, 10 or the like of the source IP address denotes a numeral by which an IP address format, such as 10.10.10.10, is simply represented.

The process 51 obtained by converting the action (behavior) of the SDN switch 23 S1 into pACSR will be described below. First, when a packet is input through the channel 1 (ch1) (ingress operation), the SDN switch 23 S1 makes a transition to process S11, whereas when a packet is input through channel 2 (ch2) (ingress operation), the SDN switch 23 S1 makes a transition to process S12. If the above condition is not satisfied, or if no packet is input, the SDN switch 23 is standing by for a single time unit, and then makes a transition to process S1 again to wait for a packet to be input.

If the SDN switch 23 S1 makes a transition to process S11, matchSrcIP(x,10) that is a predefined predicate is called to check the source IP address of packet x. If the source IP address matches 10, a single time unit is consumed while a value of ‘true’ is returned, and then the SDN switch 23 S1 makes a transition to process S13. If the source IP address does not match 10, matchSrcIP(x,10) returns a value of ‘false’ and consumes a single time unit, and then the SDN switch 23 S1 makes a transition to process S1 corresponding to the initial state thereof. At this time, the packet x is dropped.

Process S12 is configured to determine whether the source IP address of packet x matches 10 by using matchSrcIP(x,10), and is configured to, if a value of ‘true’ is acquired as a result of the determination, that is, if the source IP address matches 10, consume a single time unit and then allow the SDN switch 23 S1 to make a transition to process S13.

Process S13 is configured to output the packet x through the channel 3 (ch3) (egress operation), and then the SDN switch 23 S1 makes a transition to process S1 corresponding to the initial state thereof.

Process S14 is configured to call matchSrcIP(x,11) and determine whether the source IP address of the packet x matches 11, and is configured to, if a value of ‘true’ is acquired as a result of the determination, consume a single time unit and then allow the SDN switch 23 S1 to make a transition to process S13, whereas if a value of ‘false’ is acquired, allow the SDN switch 23 S1 to make a transition to an initial state, that is, process S1. At this time, the packet x is dropped.

Processes 52 and 53 for the SDN switches S2 and S3 may be analyzed in the same manner as that of process 51.

Referring to process 54 for host E and process 55 for the entire SDN system, it can be seen that process E is initiated while transmitting packet x through channel 1 (ch1), and process S1 receives the packet x through channel 1 (ch1). Here, packet x denotes all possible packets.

The STG generation unit 121 generates a symbolic transition graph using predefined representations, as shown in FIG. 6, based on the formal language converted in this way.

The STG generation unit 121 may generate the symbolic transition graph in compliance with a rule preset in the formal language pACSR. For example, the preset rule has been described above and may be implemented using, for example, the scheme “Symbolic Schedulability Analysis of Real-time System” which is already widely known. Since this scheme “Symbolic Schedulability Analysis of Real-time System” is known technology, a detailed description thereof will be omitted.

FIG. 7 illustrates error verification for discovering a loop by applying the symbolic transition graph generated by the STG generation unit 121, as shown in FIG. 6, to a formal technique via the verification execution unit 122. The detection of a loop in an SDN environment is a very important safety property, and thus it may be regarded as a property that is a fundamental element in SDN verification.

Referring to FIG. 7, in the flow table 30 of FIG. 4, a loop is present. That is, when a packet having a source IP address matching 10 is input to the SDN switch 23 S1 through channel 1 (ch1), the packet is output through the channel 3 (ch3) of the switch S1 (egress operation), is input to the SDN switch 23 S2 (ingress operation) and is then output through channel 4 (ch4) (egress operation). After this packet has been input to the switch 23 S3, it is input again to the switch 23 S1 through channel 2 (ch2), thus forming a loop.

Below, a method in which the verification execution unit 122 detects a loop present in the flow table 30 using a symbolic transition graph will be described in detail with reference to FIG. 7.

The verification execution unit 122 gathers conditions appearing at edges whenever passing through respective states in a symbolic transition graph while following the links of the respective states, thus gradually forming a single condition. In this way, a value which satisfies the formed single condition is a value forming an actual loop.

The verification execution unit 122 represents a value satisfying the condition formed in this way by a Boolean expression, thus symbolically representing the value by a Binary Decision Diagram (BDD) or a Conjunctive Normal Form (CNF). In this case, the formed condition may be given to all arbitrary packets capable of forming a loop.

For example, it can be seen that a loop is present in the symbolic transition graph when starting from first state “S1∥S2∥S3∥E” and following a dotted line shown in the graph. That is, if conditions appearing at all edges along the dotted line shown in the drawing are gathered, m(x,10) is obtained. In this case, m(x,10) simply represents matchSrc(x,10) shown in FIG. 5. A value satisfying this condition m(x,10) may be represented by a Boolean expression, for example, a(˜b), as shown in FIG. 7, where ‘a’ denotes 1 of the source IP address 10, and ‘(˜b)’ denotes 0. This Boolean expression a(˜b) may be represented by BDD or CNF, and a(˜b) becomes a condition in which a loop is actually formed. For reference, tau@ch1 denotes synchronization with channel 1 (ch1), and means that a packet is transferred through channel 1 (ch1).

The verification execution unit 122 may verify various other properties by means of the above-described loop detection algorithm.

Generally, it is very difficult to develop an algorithm for directly verifying an interactive relationship between the flow tables of independent SDN switches, in particular, interactive parallel behavior between the flow tables of the SDN switches that are operated in parallel. However, as described above, according to the embodiment disclosed in the present invention, the interactive parallelization of flow tables of the SDN switches may be solved based on the symbolic transition graph, thus enabling various properties to be easily verified. In particular, among various properties, properties that may be represented by Linear Temporal Logic (LTL), Computational Tree Logic (CTL), etc. may also be easily verified.

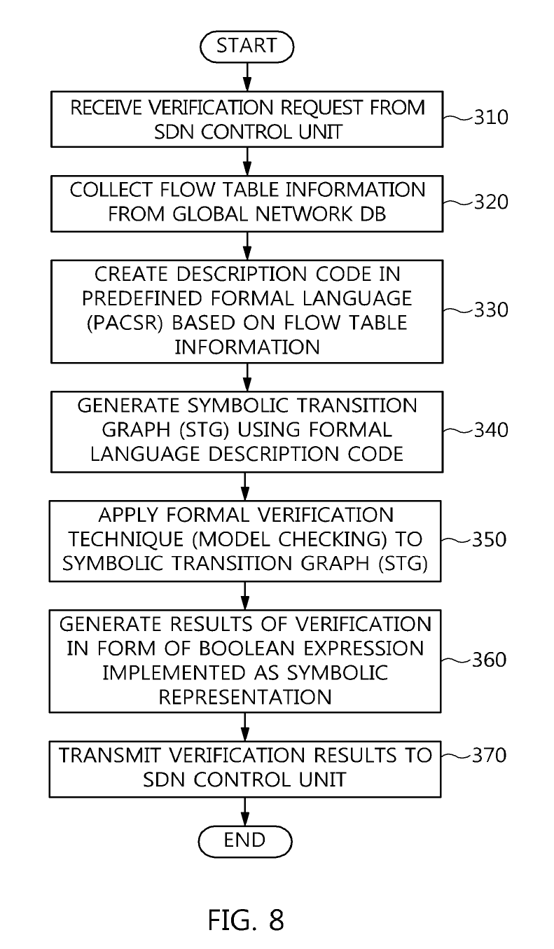

FIG. 8 is a flowchart showing a formal verification method for SDN according to an embodiment.

The method of FIG. 8 may be an embodiment of a formal verification method performed by the formal verification apparatus 100 in the SDN environment of FIG. 2. Since formal verification technology performed by the formal verification apparatus 100 has been described in detail with reference to FIG. 2 and subsequent drawings, a description will be made in brief.

First, the formal verification apparatus 100 receives a verification request from the SDN control unit at step 310. That is, the SDN control unit executes an external application, and requests the formal verification apparatus 100 to verify the results of the execution through an interface before passing the execution results down to an SDN switch.

The formal verification apparatus 100 is configured to, if the verification request has been received, collect the information of a flow table for the SDN-based entire network topology, such as that illustrated in FIG. 4, from the global network DB at step 320. In this case, the SDN-based entire network topology is illustrated in FIG. 3, and the flow table may include fields for matching, priority, counters, action set, timeout, cookies, etc., as illustrated in FIG. 4.

Next, description code in a predefined formal language, for example, pACSR, is created based on the collected flow table information at step 330. The predefined formal language pACSR has been described in detail above with reference to FIG. 5, and the field of the flow table, for example, the matching field, may be converted into a conditional clause in pACSR. Further, instructions in the action set field of the flow table may be converted into operators in pACSR. In this case, the behavior of the SDN-based entire system including the SDN control unit, the SDN switches, and the host may be converted into a single system using the symbols (∥) of a parallel composition supported by the pACSR.

Then, a predefined symbolic transition graph is generated using the created formal language description code at step 340.

Next, it is verified whether an error such as a loop is present by applying formal verification technology, for example, symbolic model checking technology, to the generated symbolic transition graph at step 350.

Thereafter, the results of the verification are generated in the form of a Boolean expression implemented using a symbolic representation at step 360. In this case, the results of the verification may be represented by, for example, a Binary Decision Diagram (BDD) or a Conjunctive Normal Form (CNF).

Then, the generated verification results are transmitted to the SDN control unit which requested verification at step 370.

In accordance with the present invention, there is an advantage in that a loop that may occur on a dynamic network configured to be executed using software by means of an SDN application, or a conflict between OpenFlow rules that may occur when multiple application programs on a single controller are executed may be previously discovered.

Accordingly, SDN applications developed by an external developer are verified in advance, thus improving the stability of an SDN network.

Those skilled in the art to which the present embodiments pertain will appreciate that the present invention may be implemented in other detailed forms without changing the technical spirit or essential features of the present invention. Therefore, the above-described embodiments should be understood to be exemplary rather than restrictive in all aspects.

What is claimed is:

1. A formal verification apparatus for Software-Defined Networking (SDN), comprising:
a formal language creation unit for collecting flow table information for an entire network topology in response to a request of a SDN control unit, and creating description code in a predefined formal language based on the collected flow table information;
a Symbolic Transition Graph (STG) generation unit for generating a symbolic transition graph using the created description code in the formal language; and
a verification execution unit for performing verification by applying formal verification technology to the symbolic transition graph.

2. The formal verification apparatus of claim 1, wherein the flow table information includes one or more of a matching field, a priority field, a counters field, and an action set field of OpenFlow.

3. The formal verification apparatus of claim 2, wherein the predefined formal language is a process algebra-based packet based Algebra of Communicating Shared Resources (pACSR).

4. The formal verification apparatus of claim 3, wherein the formal language creation unit converts the matching field into a conditional clause in the description code in the pACSR, and converts the action set field into an operator in the description code in the pACSR.

5. The formal verification apparatus of claim 3, wherein the formal language creation unit converts the flow table information into a process in the pACSR for each SDN switch, and parallelizes converted processes for respective SDN switches into a single process.

6. The formal verification apparatus of claim 1, wherein the STG generation unit converts the created description code in the formal language into the symbolic transition graph based on a rule preset in the formal language.

7. The formal verification apparatus of claim 6, wherein the preset rule includes any one of a parallel composition rule, a choice rule, an event rule, and a resource rule.

8. The formal verification apparatus of claim 1, wherein the formal verification technology comprises symbolic model checking.

9. The formal verification apparatus of claim 1, wherein the verification execution unit generates results of verification in a form of a Boolean expression implemented using a symbolic representation.

10. The formal verification apparatus of claim 9, wherein the results of the verification in the form of the Boolean expression include any one of a Binary Decision Diagram (BDD) and a Conjunctive Normal Form (CNF).

11. A formal verification method for Software-Defined Networking (SDN), comprising:
collecting flow table information for an entire network topology in response to a request of an SDN control unit;
creating description code in a predefined formal language based on the collected flow table information;
generating a symbolic transition graph using the created description code in the formal language; and
performing verification by applying formal verification technology to the symbolic transition graph.

12. The formal verification method of claim 11, wherein the flow table information includes one or more of a matching field, a priority field, a counters field, and an action set field of OpenFlow.

13. The formal verification method of claim 12, wherein the predefined formal language is a process algebra-based packet based Algebra of Communicating Shared Resources (pACSR).

14. The formal verification method of claim 13, wherein creating the description code in the formal language comprises:
converting the matching field into a conditional clause in the description code in the pACSR; and
converting the action set field into an operator in the description code in the pACSR.

15. The formal verification method of claim 13, wherein creating the description code in the formal language comprises:
converting the flow table information into a process in the pACSR for each SDN switch; and
parallelizing converted processes for respective SDN switches into a single process.

16. The formal verification method of claim 11, wherein generating the symbolic transition graph is configured to convert the created description code in the formal language into the symbolic transition graph based on a rule preset in the formal language.

17. The formal verification method of claim 16, wherein the preset rule includes any one of a parallel composition rule, a choice rule, an event rule, and a resource rule.

18. The formal verification method of claim 11, wherein the formal verification technology comprises symbolic model checking.

19. The formal verification method of claim 11, further comprising generating results of verification in a form of a Boolean expression implemented using a symbolic representation.

20. The formal verification method of claim 19, wherein the results of the verification in the form of the Boolean expression include any one of a Binary Decision Diagram (BDD) and a Conjunctive Normal Form (CNF).
